(19) United States
(12) Patent Application Publication
(10) Pub. No.: US 2024/0165984 A1
(43) Pub. Date: May 23, 2024

(54) CORRESPONDENCE AND STORAGE KIT

(71) Applicant: CICOA Aging & In-Home Solutions, Indianapolis, IN (US)

(72) Inventors: Erica Seabaugh, Indianapolis, IN (US); Jonathan Haag, Indianapolis, IN (US)

(21) Appl. No.: 18/518,148

(22) Filed: Nov. 22, 2023

Related U.S. Application Data
(60) Provisional application No. 63/427,409, filed on Nov. 22, 2022.

(51) Int. Cl. B42D 1/00; B42D 15/02

(52) U.S. Cl. CPC B42D 1/009; B42D 15/02

(57) ABSTRACT

A correspondence kit for encouraging meaningful written communication between two users. The present disclosure includes a correspondence kit containing two books and a plurality of post cards to be exchanged between the users with features to encourage use and retention of the post cards.

### PRIORITY CLAIM

This application claims priority under 35 U.S.C. § 119(e) to U.S. Provisional Application Ser. No. 63/427,409, filed Nov. 22, 2022, which is expressly incorporated by reference herein.

### BACKGROUND

The present disclosure relates to a correspondence kit for encouraging meaningful written communication between two users.

### SUMMARY

The present disclosure is directed to a correspondence kit containing two books and a plurality of post cards to be exchanged between the users. The correspondence kit encourages meaningful written communication between a first user and a second user, such as a grandparent and grandchild.

In illustrative embodiments, the kit includes a first book, an identical second book, and two sets of identical post cards. The first book will be retained by the first user and the second book will be retained by the second user. The post cards will be filled in according to prompts from the books, exchanged by the users, and stored in the books for future reading.

In illustrative embodiments, the kit may form part of a larger system including a digital input device and a computer server. The computer server can receive images and/or data recorded by the digital input device related to the correspondence kit, and in particular related to the post cards after they are filled in. The computer server can associate the images and/or data with a particular prompt based on associating features printed on the post card. Further, the computer server can associate the images and/or data with a particular user based on name or address data written on the post card. The computer server can also store the images and/or data and to distribute the images and/or data to electronic user devices. In some embodiments, images and/or data are distributed only to associated users so as to keep unique post card data private and/or unique to a specific user.

### BRIEF DESCRIPTIONS OF THE DRAWINGS

The detailed description particularly refers to the accompanying figures in which:

FIG. 1 is a front elevation view of a correspondence kit for encouraging meaningful written communication between the user of a first book and the user of a second book included in the correspondence kit as they exchange post cards provided in blank form upon purchase of the kit that are sized for long-term storage in one of the first books and the second book after being filled in as suggested in FIGS. 2-4;

FIG. 2 is a front elevation view of the correspondence kit of FIG. 1 with the post cards removed from the associated first and second books to reveal a matched set of post cards provided with each of the books so that users can complete and exchange corresponding sets of post cards as suggested in FIGS. 3-4;

FIG. 3 is an internal view of one of the two identical books of FIGS. 1 and 2 showing a pages of the book including (i) a pocket page with a pocket flap attached to form a pocket sized to store post cards while exposing part of the post card to remain visible to the users and (ii) a prompt page having a prompt section to guide users on what to communicate to each other as well as a sketchpad section to provide space for users to create notes or drawings;

FIG. 4 is another internal view of the book from FIG. 3 with the post card removed from the pocket showing the associating features printed on the pocket page, the prompt page, and an associated post card, such as matching colors of the included graphics and matching numbers;

FIG. 5 is a front elevation view of one of the post cards from FIGS. 2-4 showing the mailing side of the post card which includes associating features used to match the post card to specific a specific set of pages in the book, an area for a stamp to be placed for shipping the post card, and areas for the user to fill in mailing and return addresses;

FIG. 6 is a rear view of the post card of FIG. 5 showing the message side of the post card where users can include written communications or drawings in response to the prompt presented on the prompt side of the book;

FIG. 7 is a flowchart showing directions for use of the correspondence kit that may be printed on an instruction card including the steps of sharing one of the books with another user, responding to the prompts provided in the prompt, sending the filled-in post card to the other user, and storing a filled-in post card received from the other user;

FIG. 8 is an illustration showing a system incorporating the correspondence kit suggesting one potential flow of information collected from the post cards, the flow including automatically detecting information from a post card received by the postal service and storing that information on a computer server where that information can be used in mobile phone applications, for creating non-fungible tokens, or used in a metaverse or other online application;

FIG. 9 is a flowchart showing an algorithm, which could be implemented on the server included in the system of FIG. 8, the algorithm would allow for automated decisions on when to store data received from the post card and when to send users reminders to complete their post cards.

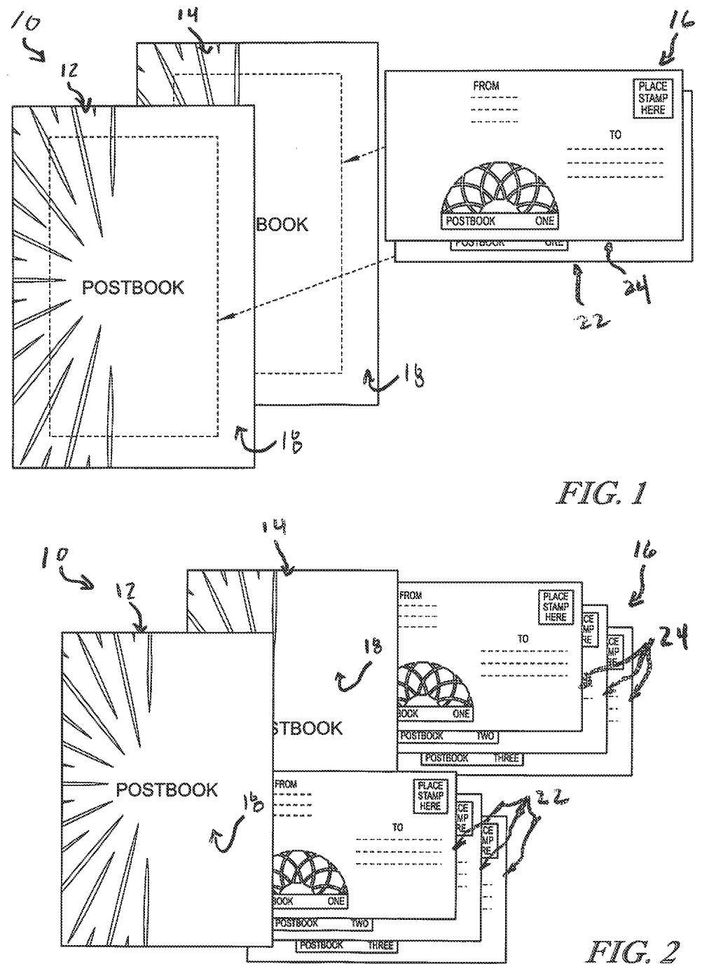

### DETAILED DESCRIPTION

A correspondence kit 10 for encouraging meaningful written communication between a first user and a second user includes a first book 12, an identical second book 14, and two sets of identical post cards 16. The first book 12 will be retained by the first user and the second book 14 will be retained by the second user. The post cards 16 will be filled in according to prompts from the books 12, 14, exchanged by the users, and stored in the books 12, 14 for future reading.

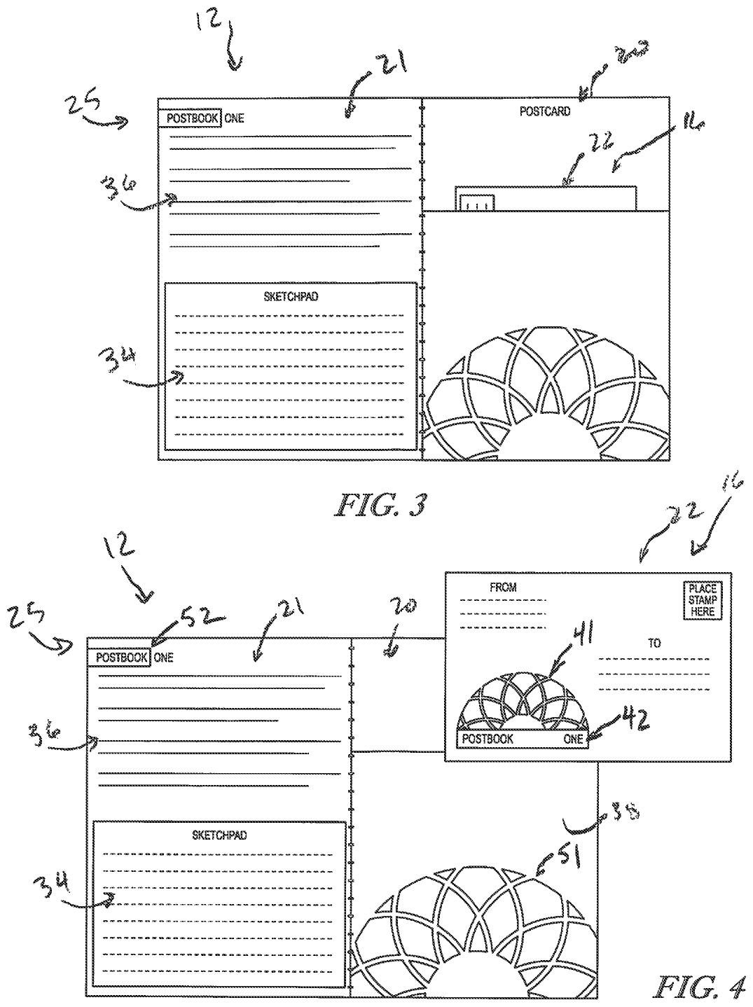

The first book 12 and the second book 14 each include a book cover 18, pocket pages 20, and prompt pages 21 as shown in FIGS. 3 and 4. Book covers 18 which extend around the exterior of the books 12, 14 protecting the pages and internally stored post cards 16 from wear and tear. The book covers 18 also include aesthetically pleasing ornamental designs.

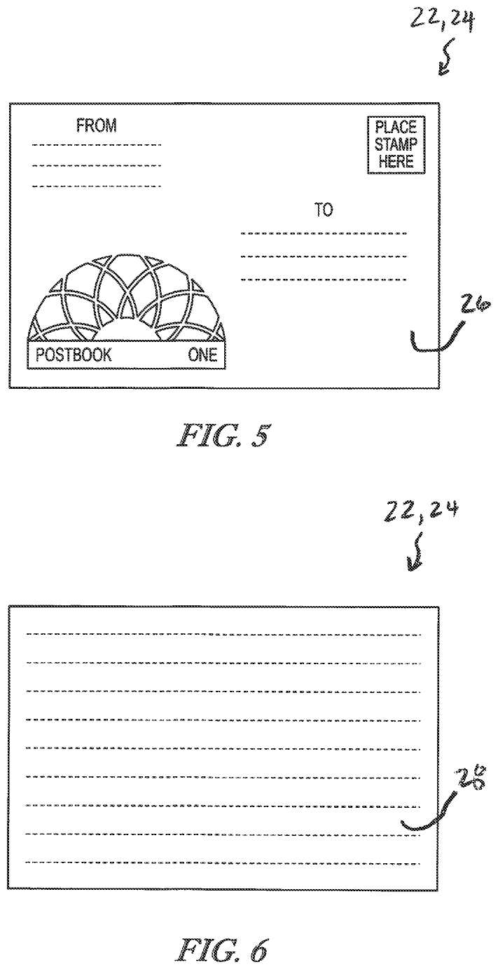

The post cards 16 are made up of a first set of post cards 22 and an identical second set of post cards 24 as shown in FIG. 2. The blank post cards 22, 24 each contain a mailing side 26 and a message side 28, as shown on FIGS. 5 and 6. Both users will be directed to include messages on the message side 26 and mailing addresses on the blank mailing side 28 before exchanging completed post cards.

The mailing side 26 of the post cards 16 includes card associating features 41, 42 used to match the post card 16 to a specific page or pages 20, 21 with book associating features 51, 52 in the books 12, 14. In the illustrated embodiment, designs and page numbers are used as associating features. Colors, designs, keywords, and other features may be used.

The pocket pages 20 include pocket flaps 38, as shown on FIG. 4. The prompt pages 21 each contain a sketch pad 34 and a prompt 36. A reading view 25 is established when one corresponding prompt page and pocket page are exposed by opening the book 12, 14 to a specific location. Each reading view 25 represents a theme for users to communicate with each other. The prompt 36 provides topics to ponder and sparks conversations between the users.

The sketchpads 34 provide an area for the users to jot down thoughts which might come to mind. The pocket flaps 38 securely store the blank post cards 22, 24 leaving a small portion exposed for visibility to the users, as shown in FIG. 3.

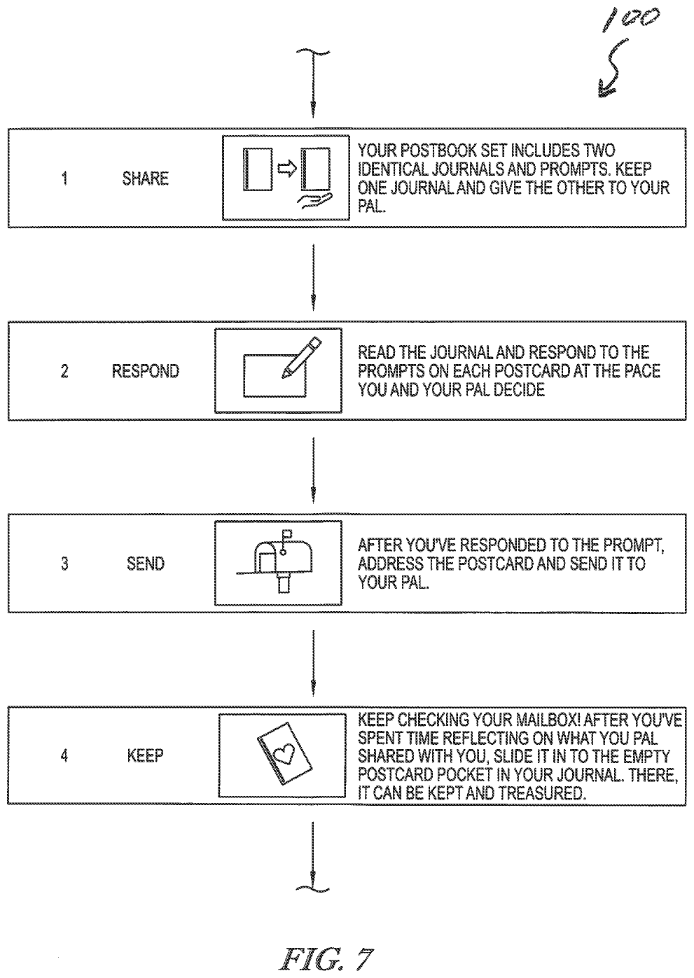

According to one method of use 100, a first user receives a correspondence kit 10 and shares the contents with a second user as suggested in FIG. 7. The first user keeps the first book 12 and provides the second book 14 to the second user. The instruction cards 16 may be retrieved from the correspondence kit 10 to provide instructions to the users. The users open up the first book 12 and the second book 14 to a reading view 25 and read the prompt 36. The users reflect on the prompt 36 and record their thoughts with notes or drawings on the sketch pad 34.

The first user creates a completed post card 30 by writing a message on the message side 26 of a blank post card 22 from the first book 12 and writing a mailing address on the mailing side 28. The second user creates a completed post card 32 by writing a message on the message side 26 of a blank post card 24 from the second book 14 and writing a mailing address on the mailing side 28.

The first user sends the completed post card 30 from the first book 12 to the second user. The second user receives the completed post card 30 from the first book 12 and stores it in the corresponding pocket flap 38 of the second book 14 which is in his possession.

The second user sends the completed post card 32 from the second book 14 to the first user. The first user receives the completed post card 32 from the second book 14 and stores it in the corresponding pocket flap 38 of the first book 12 which is in her possession.

Both users move on to the next reading view 20 of their books 12, 14 and repeat the process of reading prompts 36, recording their thoughts on the sketchpads 34, creating completed post cards 30, 32 from the books 12, 14 until all the reading views 20 are exhausted.

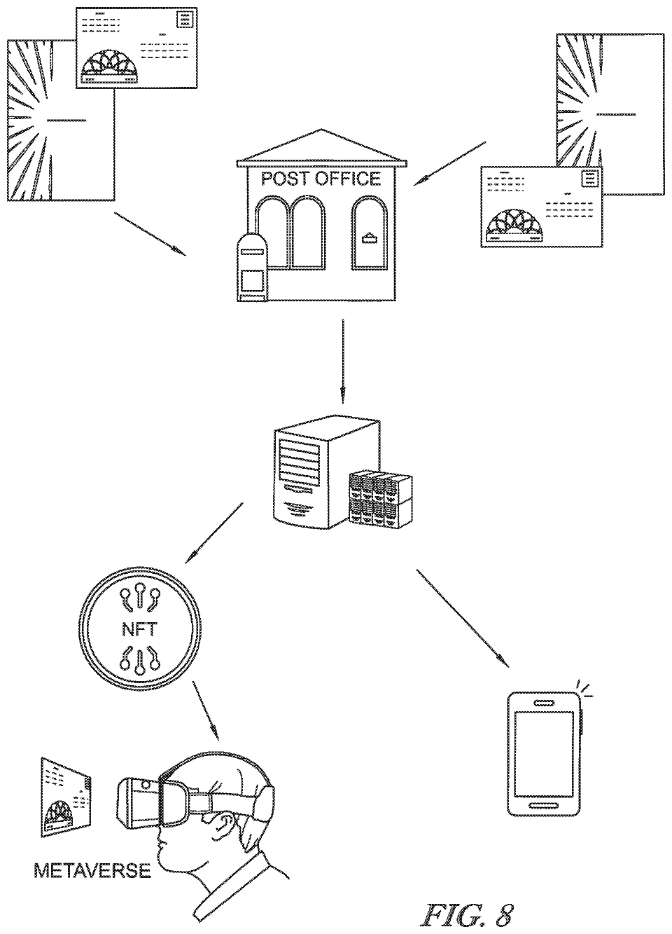

In some embodiments, information contained in the completed post cards 30, 32 may be automatically detected by the postal service, a third-party forwarding service, and/or a user and stored on a computer server 212 as part of a system 210 leveraging the correspondence kit 10 as suggested in FIG. 8. In some embodiments, images and/or data from the correspondence kit 10 may be collected via cell phone cameras, digital camera, scanners, computers or other input devices. In some embodiments, the information collected may be used in mobile phone applications, for creating non-fungible tokens (NFTs), or for various purposes in metaverse applications and other online/offline applications as suggested in FIG. 8.

The computer server 212 can associate the images and/or data with a particular prompt based on associating features printed on the post card. Further, the computer server 212 can associate the images and/or data with a particular user based on name or address data written on the post card. The computer server 212 can also store the images and/or data and to distribute the images and/or data to electronic user devices. In some embodiments, images and/or data (or associated NFTs) are distributed only to associated users so as to keep unique post card data private and/or unique to a specific user.

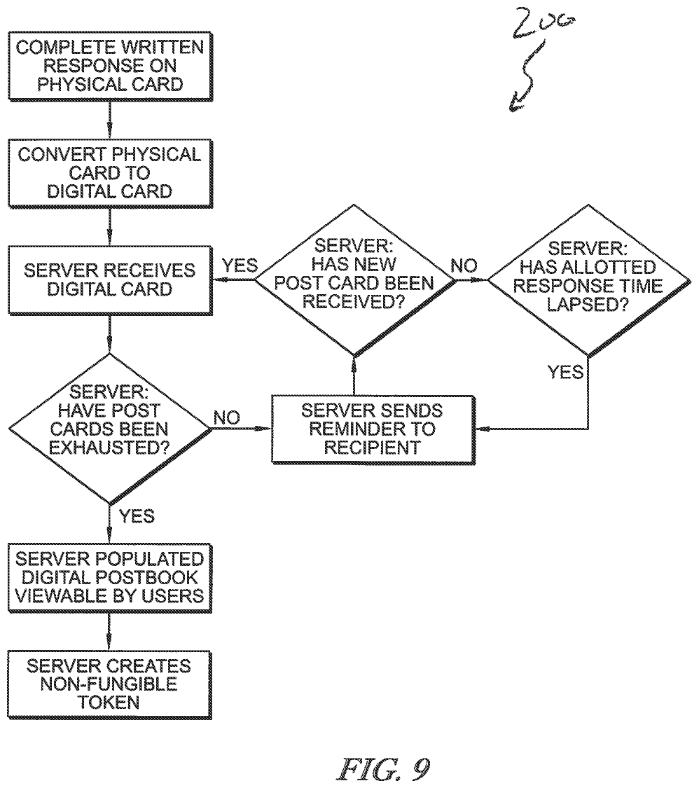

In some embodiments, an algorithm or method 200 may be implemented on the server included in the system of FIG. 8 allowing the system to send users automated reminders to complete their post cards, as suggested in FIG. 9.

1. A correspondence kit, the kit comprising
a first book having a protective cover and a plurality of pages bound to the cover, the plurality of pages including pocket pages with an attached flap forming a pocket and prompt pages including a pre-printed prompt suggesting a particular topic,
a second book, identical to the first book, having a protective cover and a plurality of pages bound to the cover, the plurality of pages including pocket pages with an attached flap forming a pocket and prompt pages including a pre-printed prompt suggesting a particular topic, and
post cards including a first set of post cards each sized to fit within a corresponding pocket formed by a pocket page in the first book and a second set of post cards each sized to fit within a corresponding pocket formed by a pocket page in the second book, wherein each post card has a message side with space for a user to respond to one of the pre-printed prompts so that users of the first book and the second book can respond to the prompt and exchange post cards to encourage meaningful written communication between the users with a built-in storage location adjacent to the associated pre-printed prompt whereby completed post cards may be kept.

2. The kit of claim 1, wherein each post card includes at least one card associating feature configured to match a book associating feature printed on a specific page in both the first book and the second book so that each post card can be easily placed with an associated prompt page in the first book or the second book.

3. The kit of claim 2, wherein the card associating feature is selected from one of a design, image, color, label, or keyword.

4. The kit of claim 3, wherein the book associating feature is selected from one of a design, image, color, label, or keyword.

5. The kit of claim 1, wherein each post card of the first set of post cards is sized to fit within the corresponding pocket formed by the pocket page in the first book with a minority portion of each post card extending out of the pocket so as to facilitate removal by a user.

6. A communication system, the system comprising
a correspondence kit including
a first book having a protective cover and a plurality of pages bound to the cover, the plurality of pages including pocket pages with an attached flap forming a pocket and prompt pages including a pre-printed prompt suggesting a particular topic,
a second book, identical to the first book, having a protective cover and a plurality of pages bound to the cover, the plurality of pages including pocket pages with an attached flap forming a pocket and prompt pages including a pre-printed prompt suggesting a particular topic, and
post cards including a first set of post cards each sized to fit within a corresponding pocket formed by a pocket page in the first book and a second set of post cards each sized to fit within a corresponding pocket formed by a pocket page in the second book,
a digital input device, and
a computer server configured to receive images and/or data recorded by the digital input device related to the correspondence kit, to store the images and/or data, and to distribute the images and/or data to electronic user devices.

7. The system of claim 5, wherein the digital input device is selected from one or more of cell phone cameras, digital camera, scanners.

8. The system of claim 7, wherein the digital input device is located in a postal processing facility.

9. The system of claim 5, wherein the computer server is further configured to create a digital non-fungible token associated with images and/or data recorded by the digital input device so as to produce only one non-fungible token associated with one of the post cards.

10. A method of communication, the method including providing a correspondence kit including
a first book having a protective cover and a plurality of pages bound to the cover, the plurality of pages including pocket pages with an attached flap forming a pocket and prompt pages including a pre-printed prompt suggesting a particular topic,
a second book, identical to the first book, having a protective cover and a plurality of pages bound to the cover, the plurality of pages including pocket pages with an attached flap forming a pocket and prompt pages including a pre-printed prompt suggesting a particular topic, and
post cards including a first set of post cards each sized to fit within a corresponding pocket formed by a pocket page in the first book and a second set of post cards each sized to fit within a corresponding pocket formed by a pocket page in the second book.

11. The method of claim 10, further comprising sharing the first book and the second book as well as the first set of post cards and the second set of post cards between first and second users.

12. The method of claim 10, further comprising
responding to the pre-printed prompts by filling in a postcard and
sending a filled-in postcard to one of the first user and the second user.

13. The method of claim 12, further comprising keeping a filled-in postcard in a pocket within the first book or the second book to avoid loss or damage to the filled-in postcard.
